(19) United States
(12) Patent Application Publication
(10) Pub. No.: US 2026/0316457 A1
(43) Pub. Date: Oct. 15, 2026

(54) IMAGE FORMING APPARATUS

(71) Applicant: Kimito Abe, Kanagawa (JP)

(72) Inventor: Kimito Abe, Kanagawa (JP)

(73) Assignee: Ricoh Company, Ltd., Tokyo (JP)

(21) Appl. No.: 19/466,954

(22) Filed: Feb. 2, 2026

(30) Foreign Application Priority Data
Mar. 19, 2025 (JP) 2025-044373

(51) Int. Cl. B41J 2/21; B41J 11/00

(52) U.S. Cl. CPC B41J 2/2103; B41J 11/0015; B41J 11/008

(57) ABSTRACT

An image forming apparatus includes: a first head array having a first printable region having a first printable width in a width direction, to apply a pretreatment liquid on a medium conveyed in a conveyance direction orthogonal to the width direction; a second head array having a second printable region having a second printable width smaller than the first printable width in the width direction, to apply ink onto the medium; and circuitry configured to control the first head array and the second head array to apply the ink over the pretreatment liquid on the medium.

### CROSS-REFERENCE TO RELATED APPLICATIONS

This patent application is based on and claims priority pursuant to 35 U.S.C. § 119(a) to Japanese Patent Application No. 2025-044373, filed on Mar. 19, 2025, in the Japan Patent Office, the entire disclosure of which is hereby incorporated by reference herein.

### BACKGROUND

### Technical Field

The present embodiment relates to an image forming apparatus.

### Related Art

The image forming apparatus applies a pretreatment liquid to a medium and performs printing on the medium to which the pretreatment liquid is applied in order to prevent density unevenness and blur of printing ink. In order to improve image friction resistance, a post-treatment liquid is applied to the medium after printing on the medium.

Since the treatment liquid that is not the printing ink is generally colorless, it is difficult to correctly adjust a landing position, and misregistration is likely to occur more easily than the printing ink. Considering that misregistration of the treatment liquid is likely to occur, the treatment liquid is applied to a region slightly wider than the region to which the printing ink is applied.

However, in the technique of applying the treatment liquid of the image forming apparatus described above, since the printable regions of the printing ink and the treatment liquid are the same, in a case where misregistration occurs, there is a possibility that an image is printed beyond the printable region of the treatment liquid at an end. Then, the utility of the treatment liquid cannot be obtained at the end.

### SUMMARY

The present disclosure described herein provides an image forming apparatus including: a first head array having a first printable region having a first printable width in a width direction, to apply a pretreatment liquid on a medium conveyed in a conveyance direction orthogonal to the width direction; a second head array having a second printable region having a second printable width smaller than the first printable width in the width direction, to apply ink onto the medium; and circuitry configured to control the first head array and the second head array to apply the ink over the pretreatment liquid on the medium.

### BRIEF DESCRIPTIONS OF DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic view of an inkjet printer;

FIG. 2 is an enlarged view illustrating a print unit in the inkjet printer;

FIG. 3 is a plan view illustrating an example of a head unit in the inkjet printer;

FIG. 4 is an external perspective view illustrating an example of an inkjet head in the inkjet printer;

FIG. 5 is a cross-sectional view in a longitudinal direction of a liquid chamber orthogonal to a nozzle array direction of the inkjet head in the inkjet printer;

FIG. 6 is a schematic view for illustrating nozzle arrangement in a head array of a head unit of the inkjet printer;

FIGS. 7A and 7B are explanatory views for illustrating a problem in a case where printable regions or printable widths of printing ink and a pretreatment liquid are the same in a line type inkjet printer;

FIG. 8 is an explanatory view illustrating a configuration in which a printable region of the pretreatment liquid head array is made wider than a printable region of the printing ink head array in the inkjet printer;

FIGS. 9A to 9C are schematic views illustrating a specific configuration for widening the printable region of the pretreatment liquid head array more than the printable region of the printing ink head array in one or multiple embodiments;

FIG. 10 is a functional block diagram of a controller of the inkjet printer;

FIGS. 11A and 11B are flowcharts illustrating data processing at the time of printing executed in the inkjet printer;

FIGS. 12A and 12B are explanatory views of processing of calculating a pretreatment liquid application region from color plate data of KCMY in the inkjet printer;

FIGS. 13A and 13B are explanatory views of halftone processing of a pretreatment liquid application region in the inkjet printer;

FIG. 14 is an explanatory view (1/3) for illustrating pretreatment region calculation processing executed in the inkjet printer;

FIG. 15 is an explanatory view (2/3) for illustrating pretreatment region calculation processing executed in the inkjet printer; and

FIG. 16 is an explanatory view (3/3) for illustrating pretreatment region calculation processing executed in the inkjet printer.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, an image forming apparatus will be described in detail with reference to the drawings. However, the image forming apparatus is not limited to that described below. In the following description, the same or similar members or functions will be referred to using the same names and reference numerals, and detailed description will be omitted as appropriate.

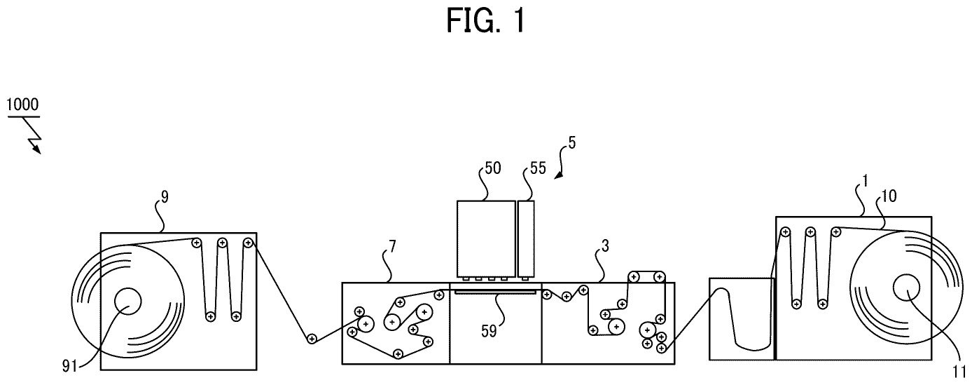

Hereinafter, an image forming apparatus will be described with reference to FIGS. 1 to 16. Note that, in the embodiment described below, although not particularly limited, a single-pass inkjet printer will be described as an example of an image forming apparatus.

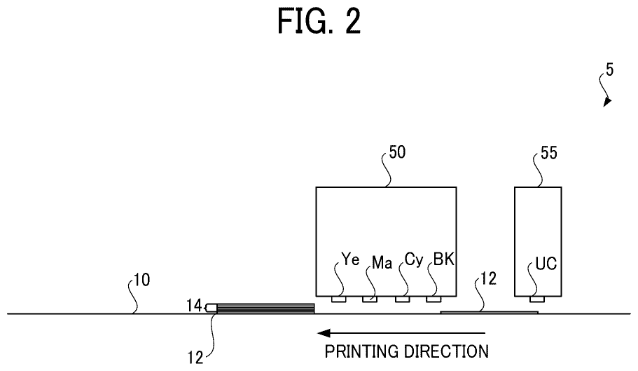

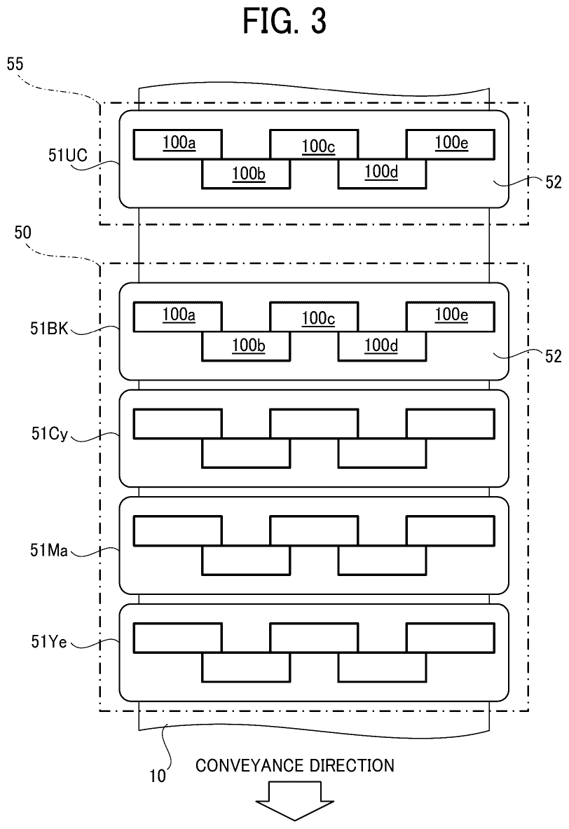

Hereinafter, an overall configuration of an inkjet printer that is an image forming apparatus will be described with reference to FIGS. 1 to 3. FIG. 1 is a schematic view of an inkjet printer 1000 (simply referred to as a printer). FIG. 2 is an enlarged schematic view of the periphery of a head unit of a print unit of the printer 1000. FIG. 3 is a plan view of an example of the head unit of the printer 1000.

The printer 1000 includes a carry-in unit 1 that carries in a continuous body 10 that is a medium, a guide conveyance unit 3 that guides and conveys the continuous body 10 carried in from the carry-in unit 1 to a print unit 5, the print unit 5 that performs printing of discharging ink to the continuous body 10 to form an image, a drying unit 7 that dries the continuous body 10, and a delivery unit 9 that delivers the continuous body 10.

The continuous body 10 is fed from an original winding roller 11 of the carry-in unit 1, guided and conveyed by respective rollers of the carry-in unit 1, the guide conveyance unit 3, the drying unit 7, and the delivery unit 9, and wound by a winding roller 91 of the delivery unit 9.

In the print unit 5, the continuous body 10 is conveyed on a conveyance guide member 59 so as to be opposed to a pretreatment head unit 55 and a printing head unit 50, and a pretreatment liquid discharged from the pretreatment head unit 55 is applied to form a pretreatment layer 12 on the continuous body 10. In the continuous body 10, an image 14 is further formed on the pretreatment layer 12 by printing ink discharged from the printing head unit 50. The printing head unit may be referred to as a “head unit”.

As illustrated in FIGS. 2 and 3, the printing head unit 50 is disposed downstream of the pretreatment head unit 55 in a medium conveyance direction. The “medium conveyance direction” may be referred to as “conveyance direction”. In the printing head unit 50, for example, full-line type head arrays 51BK, 51Cy, 51Ma, and 51Ye for four colors (hereinafter referred to as a “head array 51” when colors are not distinguished) are arranged from an upstream side in a conveyance direction as illustrated in FIGS. 2 and 3.

Each head array 51 is configured to discharge liquid, and discharges printing ink of black BK, cyan Cy, magenta Ma, or yellow Ye to the conveyed continuous body 10. The number and types of colors are not limited to them.

As illustrated in FIGS. 2 and 3, the pretreatment head unit 55 is disposed upstream of the printing head unit 50 in the conveyance direction. A full-line type head array 51UC (hereinafter, referred to as a “head array 51” also when there is no distinction in color, printing ink, and pretreatment liquid) is also disposed in the pretreatment head unit 55. The head array 51UC is configured to discharge the pretreatment liquid. The head array 51UC may be referred to as “a pretreatment liquid head array”, or “a second head array”.

As illustrated in FIG. 3, for example, each head array 51 of the printing head unit 50 and the pretreatment head unit 55 is formed by arranging inkjet heads (hereinafter, also simply referred to as heads) 100 in a staggered manner on a base member 52.

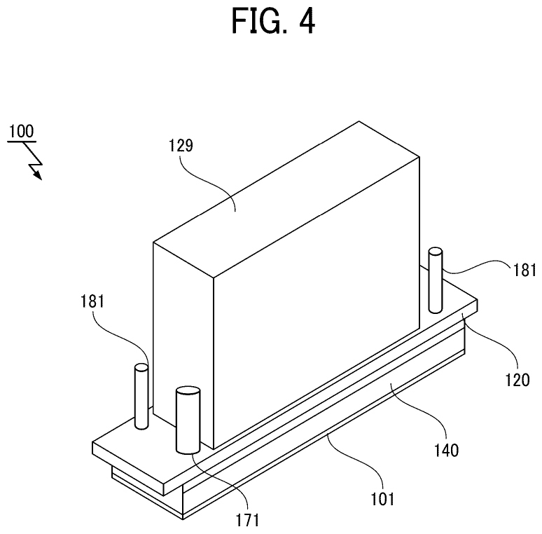

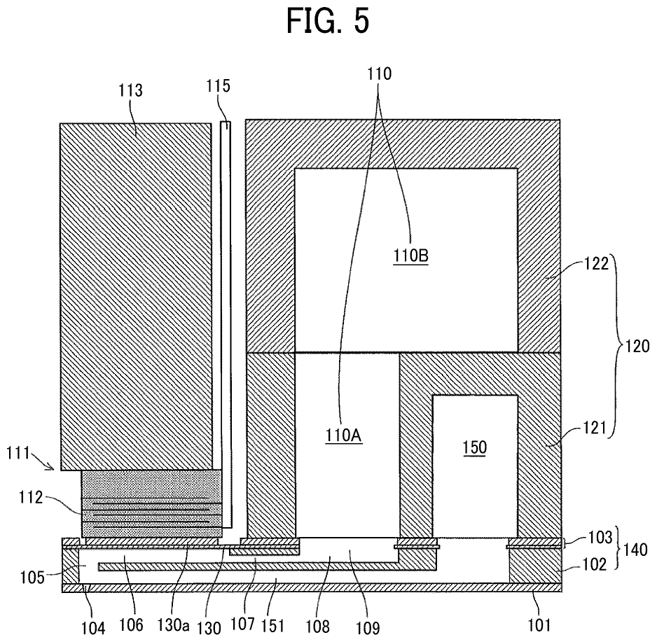

Next, an example of the head 100 will be described with reference to FIGS. 4 and 5. FIG. 4 is an external perspective view of the head 100. FIG. 5 is a cross-sectional view in a longitudinal direction of the liquid chamber orthogonal to a nozzle array direction of the head.

The head 100 is obtained by stacking and bonding a nozzle plate 101, a channel plate 102, and a diaphragm member 103 as a wall member. The head 100 further includes a piezoelectric actuator 111 to displace a vibration region 130 of the diaphragm member 103, a common liquid chamber member 120 that also serves as a frame of the head 100, and a cover 129. A portion of the head 100 formed by the channel plate 102 and the diaphragm member 103 is referred to as a channel member 140.

The nozzle plate 101 includes multiple nozzles 104 for discharging the pretreatment liquid or the printing ink. The channel plate 102 includes through holes and grooves that define individual chambers 106, supply-side liquid restrictors 107, and liquid inlets 108. The individual chambers 106 communicate with the nozzles 104 via nozzle communication channels 105, respectively. The supply-side liquid restrictors 107 communicate with the individual chambers 106, respectively. The liquid inlets 108 communicate with the supply-side liquid restrictors 107, respectively. The nozzle communication channels 105 connect the nozzles 104 and the individual chambers 106, respectively. The liquid inlets 108 communicate with a supply-side common liquid chamber 110 through openings 109 of the diaphragm member 103.

The diaphragm member 103 includes deformable vibration regions 130 serving as a wall of the individual chambers 106 of the channel plate 102. The diaphragm member 103 has a two-layer structure but is not limited to the same, and includes a first layer forming a thin portion and a second layer forming a thick portion arranged in this order from a side of the channel plate 102, and the deformable vibration region 130 is formed in a portion corresponding to the individual chamber 106 in the first layer.

The piezoelectric actuator 111 including an electromechanical conversion element to deform the vibration region 130 of the diaphragm member 103 is disposed on a side opposite to the individual chamber 106 of the diaphragm member 103.

The piezoelectric actuator 111 includes a desired number of pillar-shaped piezoelectric elements 112 formed into a comb shape at certain intervals by grooving a piezoelectric member bonded onto a base 113 by half-cut dicing.

The piezoelectric element 112 is bonded to a projection 130a, which is an island-shaped thick portion on the vibration region 130 of the diaphragm member 103. A flexible wiring member 115 is connected to the piezoelectric element 112.

The common liquid chamber member 120 defines the supply-side common liquid chamber 110 and a delivery-side common liquid chamber 150. The supply-side common liquid chamber 110 communicates with a supply port 171, and the delivery-side common liquid chamber 150 communicates with a delivery port 181.

The common liquid chamber member 120 herein includes a first common liquid chamber member 121 and a second common liquid chamber member 122. The first common liquid chamber member 121 is bonded to the diaphragm member 103 of the channel member 140. The second common liquid chamber member 122 is stacked on and bonded to the first common liquid chamber member 121.

The first common liquid chamber member 121 defines a downstream common liquid chamber 110A and a delivery-side common liquid chamber 150. The downstream common liquid chamber 110A is a part of the supply-side common liquid chamber 110 communicating with the liquid inlets 108. The delivery-side common liquid chamber 150 communicates with delivery channels 151. The second common liquid chamber member 122 defines an upstream common liquid chamber 110B, which is the remaining part of the supply-side common liquid chamber 110.

The channel plate 102 further includes the delivery channels 151 extending in a plane direction of the channel plate 102 communicating with the individual chambers 106 via the nozzle communication channels 105, respectively. The delivery channels 151 also communicate with the delivery-side common liquid chamber 150.

In the head 100, for example, a voltage to be applied to the piezoelectric element 112 is lowered from a reference potential (intermediate potential) so that the piezoelectric element 112 contracts to pull the vibration region 130 of the diaphragm member 103 to increase the volume of the individual chamber 106. As a result, the pretreatment liquid or printing ink flows into the individual chamber 106.

Thereafter, the voltage to be applied to the piezoelectric element 112 is increased to extend the piezoelectric element 112 in a stacking direction, and the vibration region 130 of the diaphragm member 103 is deformed in a direction toward the nozzle 104 to contract the volume of the individual chamber 106, so that the pretreatment liquid or the printing ink in the individual chamber 106 is pressurized, and the pretreatment liquid or the printing ink is discharged from the nozzle 104.

The pretreatment liquid or the printing ink that has not been discharged from the nozzle 104 passes through the nozzle 104 and is delivered to the delivery-side common liquid chamber 150 through the delivery channel 151 and then supplied again from the delivery-side common liquid chamber 150 to the supply-side common liquid chamber 110 through an external liquid circulation path.

A drive method of the head is not limited to the above-described example of pull-push discharging, and pull discharging or push discharging may be performed depending on how a drive waveform is applied.

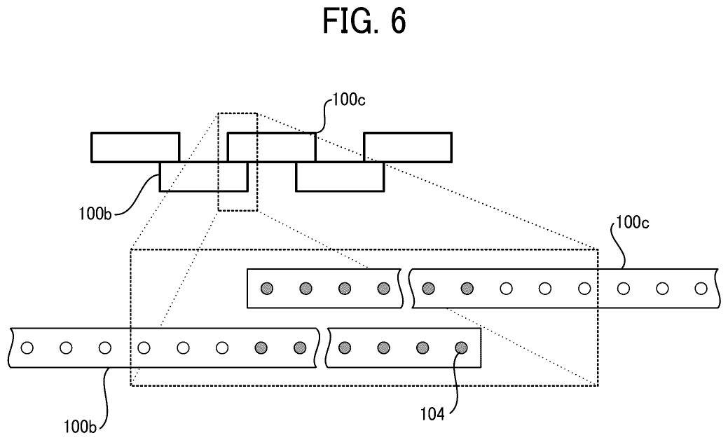

Next, nozzle arrangement in the head array 51 will be described with reference to FIG. 6. FIG. 6 is a schematic view for illustrating the nozzle arrangement of the heads 100 in the head array 51 of the head units 50 and 55. As illustrated in FIG. 6, in the head array 51, multiple heads 100a to 100e are arranged in a staggered manner (alternately in the conveyance direction). In a connecting portion between the heads of the head array 51, the nozzles 104 of the heads arranged in a staggered manner are arranged so as to overlap with each other in the conveyance direction. In FIG. 6, the overlapping nozzles 104 are indicated by gray circle. Printing of the connecting portion of the heads 100 is performed using either of the overlapping nozzles 104.

In the technique of discharging the pretreatment liquid by the head 100 described above, it is required to consider a printable region of each of the printing ink and the pretreatment liquid.

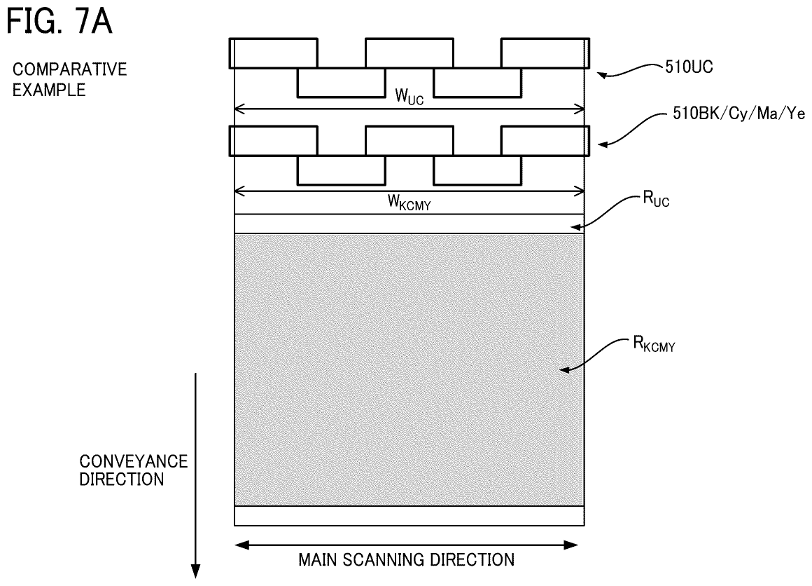

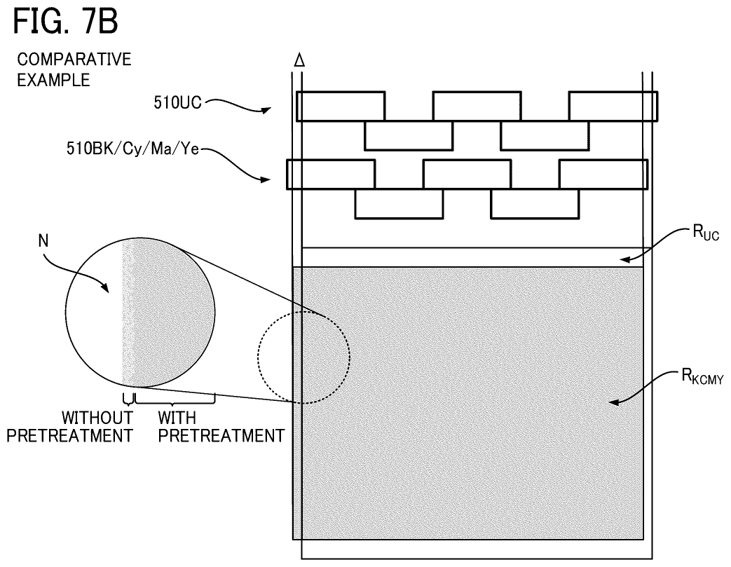

FIGS. 7A and 7B are diagrams for illustrating a problem in a case where printable regions or printable widths of the printing ink and the pretreatment liquid are the same (within an allowable tolerance) in a line type inkjet printer. As illustrated in FIG. 7A, in a case where a printable width W_{KCMY} of the printing ink by an ink head array 510BK/510Cy/510Ma/510Ye and a printable width WUC of the pretreatment liquid by a pretreatment liquid head array 510UC are the same, a disadvantage might occur in a case where misregistration Δ between a color image and the pretreatment liquid occurs in a main scanning direction (direction orthogonal to the conveyance direction). In particular, since the pretreatment liquid is colorless, it is difficult to correctly adjust a landing position, and misregistration tends to occur more easily than in the color image.

At the center of the ink head array 510BK/510Cy/510Ma/510Ye inside the printable width W_{UC}, an application region of the pretreatment liquid is made slightly wider than that of the color image, so that it is possible to prevent blur due to the misregistration Δ described above. However, in a case where the printable widths W_{UC} and W_{KCMY} of the color image and the pretreatment liquid are the same, if the misregistration Δ occurs, as illustrated in an enlarged manner in FIG. 7B, the pretreatment liquid cannot be applied to the outside of the image (the printable region R_{KCMY} is a maximum range in which an image is formed) at an end, and the color image protrudes from the application region of the pretreatment liquid. As illustrated in FIG. 7B, an abnormal image such as blur N might occur.

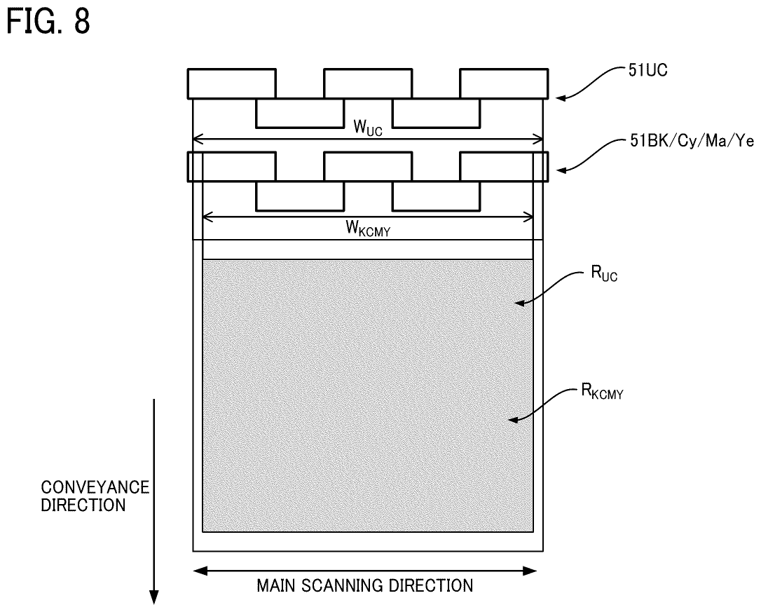

Therefore, in the embodiment to be described, in a configuration including a pretreatment liquid head array 51UC for applying the pretreatment liquid (UC ink), the printing ink head array 51BK/51Cy/51Ma/51Ye for applying the printing ink (BK/Cy/Ma/Ye ink), and a controller for controlling the pretreatment liquid head array 51UC and the printing ink head array 51BK/51Cy/51Ma/51Ye to apply the pretreatment liquid (UC ink) and the printing ink (BK/Cy/Ma/Ye ink) onto the medium in a superimposed manner, as illustrated in FIG. 8, a printable region R_{UC} (printable width W_{UC}) of the pretreatment liquid head array 51UC is wider than the printable region R_{KCMY} (printable width W_{KCMY}) of the printing ink head array 51BK/51Cy/51Ma/51Ye (designed to be wider than the allowable tolerance).

This makes it possible to prevent the image from protruding from a range of the printable region of the pretreatment liquid even when a certain degree of misregistration Δ occurs, and it is possible to prevent blur.

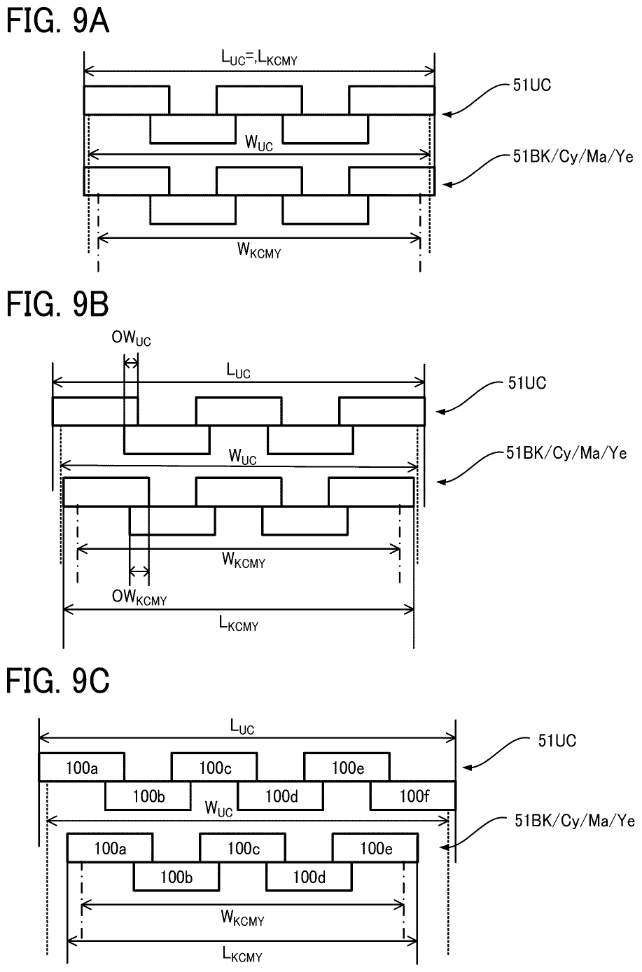

FIGS. 9A to 9C are diagrams for illustrating a specific configuration for expanding the printable region R_{UC} of the pretreatment liquid head array 51UC more than the printable region R_{KCMY} of the printing ink head array 51BK/51Cy/51Ma/51Ye in one or multiple embodiments.

FIG. 9A illustrates a more specific configuration of expanding the printable region R_{UC} of the pretreatment liquid head array 51UC according to a first embodiment. In the configuration illustrated in FIG. 9A, while physical lengths (L_{UC}, L_{KCMY}) of both the pretreatment liquid head array 51UC and the printing ink head array 51BK/51Cy/51Ma/51Ye are the same (L_{UC}=L_{KCMY}), the number of nozzles used for discharge is different, and the number of nozzles used for the pretreatment liquid is larger than the number of nozzles used for the printing ink. The number of heads is the same in the pretreatment liquid head array 51UC and the printing ink head array 51BK/51Cy/51Ma/51Ye.

As described above, also in a case where resolutions of the pretreatment liquid head array 51UC and the printing ink head array 51BK/51Cy/51Ma/51Ye are the same, the printable width W_{UC} of the pretreatment liquid can be made wider than the printable width W_{KCMY} of the color image by further increasing the number of nozzles used for the pretreatment liquid.

FIG. 9B illustrates a specific configuration for expanding the printable region R_{UC} (printable width W_{UC}) of the pretreatment liquid head array 51UC according to a second embodiment. In the embodiment illustrated in FIG. 9B, the length (width) L_{CU} of the pretreatment liquid head array 51UC is made physically longer (wider) than the length L_{KCMY} of the printing ink head array 51BK/51Cy/51Ma/51Ye. In order to increase the length (width) L_{CU} of the pretreatment liquid head array 51UC, a width OW_{UC} of an overlapping region between the heads of the pretreatment liquid head array 51UC is wider than a width of an overlapping region OW_{KCMY} between the heads of the printing ink head array 51BK/51Cy/51Ma/51Ye.

FIG. 9C illustrates a specific configuration for expanding the printable region R_{UC} (printable width W_{UC}) of the pretreatment liquid head array 51UC according to a third embodiment. In the embodiment illustrated in FIG. 9C, the length (width) L_{CU} of the pretreatment liquid head array 51UC is made physically longer (wider) than the length L_{KCMY} of the printing ink head array 51BK/51Cy/51Ma/51Ye. In order to increase the length (width) L_{CU} of the pretreatment liquid head array 51UC, the number of heads (six in FIG. 9C) of the pretreatment liquid head array 51UC is larger than the number of heads (five in FIG. 9C) of the printing ink head array 51BK/51Cy/51Ma/51Ye.

As described with reference to FIGS. 9A to 9C, the printable region R_{UC} (printable width W_{UC}) of the pretreatment liquid head array 51UC can be made wider than the printable region R_{KCMY} (printable width W_{KCMY}) of the printing ink head array 51BK/51Cy/51Ma/51Ye by controlling the number of nozzles to be used, changing the physical configuration, or both. As a result, even when a certain degree of misregistration occurs, it is possible to prevent the color image from protruding from the application region of the pretreatment liquid at an end. Depending on the properties of the pretreatment liquid to be used, blur at an end of the printable region can be prevented.

In a case of color printing, there is multiple printing ink head arrays, but typically, the printable regions are the same, so that the pretreatment liquid head array 51UC is typically designed to have a wider printable region (printable width) than all the printing ink head arrays 51BK, 51Cy, 51Ma, and 51Ye.

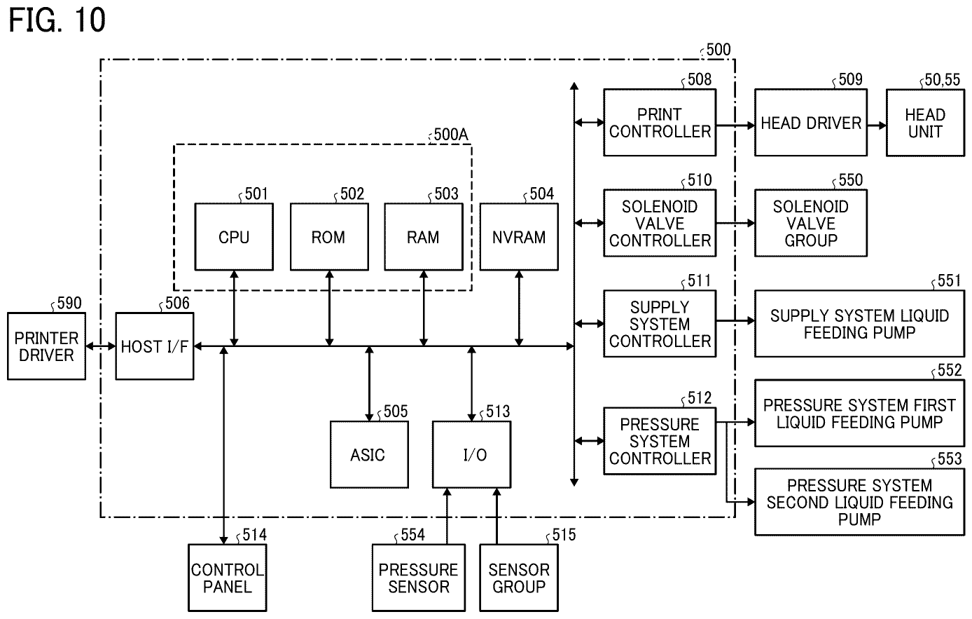

Hereinafter, the controller of the printer will be described with reference to FIG. 10. FIG. 10 is a functional block diagram of a controller 500 of the printer 1000. The controller 500 includes a main controller 500A that includes a central processing unit (CPU) 501, a read-only memory (ROM) 502, and a random-access memory (RAM) 503. The CPU 501 administrates the control of the entire apparatus. The ROM 502 stores fixed data, such as various programs including programs executed by the CPU 501. The RAM 503 temporarily stores image data and other data.

The controller 500 further includes a nonvolatile RAM (NVRAM) 504 that is rewritable and retains data while the apparatus is powered off. The controller 500 further includes an application-specific integrated circuit (ASIC) 505 that performs image processing, such as various signal processing and sorting on image data, and processing of input and output signals for other control. The controller 500 transmits and receives data to and from a printer driver 590 via a host interface (I/F) 506.

The controller 500 further includes a print controller 508 including a data transfer unit, a drive signal generation unit, and a bias voltage output unit for controlling the driving of each head 100 of the head units 50 and 55, and a drive integrated circuit (IC) 509 for driving each head 100. The drive integrated circuit (IC) 509 may be referred to as a “head driver”.

The controller 500 includes a solenoid valve controller 510 that controls the driving of solenoid valves of a solenoid valve group 550. The controller 500 includes a supply system controller 511 that controls the driving of a supply system liquid feeding pump 551. A pressure system controller 512 that controls the driving of pressure system liquid feeding pumps 552 and 553 is provided.

The controller 500 includes an I/O unit 513. The I/O unit 513 can perform processing of various pieces of sensor information to acquire a detection result of a pressure sensor 554 and information from a various sensor group 515. The I/O unit 513 extracts information required for controlling the apparatus, and the print controller 508, the solenoid valve controller 510, the supply system controller 511, and the pressure system controller 512 use the data to control the respective components. The controller 500 is connected to a control panel 514 to input and display information required for the apparatus.

The controller 500 further controls the pretreatment liquid head array 51UC and the printing ink head arrays 51BK, 51Cy, 51Ma, and 51Ye to apply the pretreatment liquid and the printing ink onto the medium in an overlapping manner. The pretreatment liquid is applied as an under coat on both a printing region where the printing ink is applied and a boundary region around the printing region.

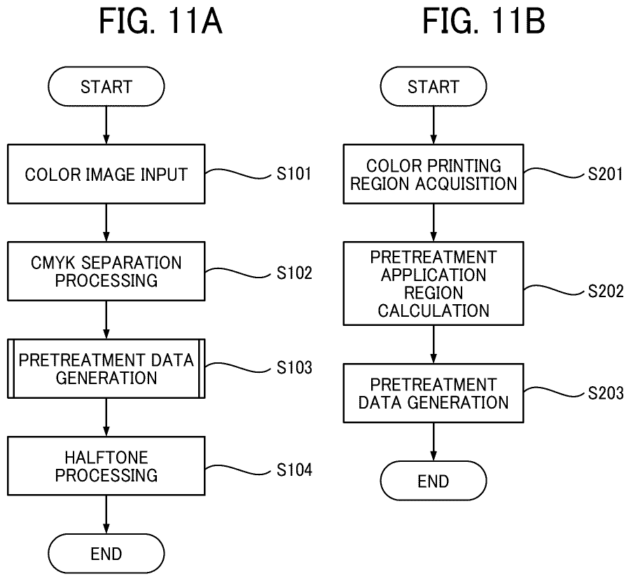

Hereinafter, the image forming processing using the pretreatment liquid head array 51UC and the printing ink head array 51BK/51Cy/51Ma/51Ye will be described in more detail with reference to FIGS. 11 to 16.

FIG. 11A is a flowchart illustrating an overall flow of data processing at the time of printing executed in the printer.

The processing illustrated in FIG. 11A starts from step S100. At step S101, the controller 500 receives an input of an RGB color image. At step S102, the controller 500 executes KCMY separation processing and divides the RGB color image into color plate data of each color of KCMY. At step S103, the controller 500 executes pretreatment data generation processing based on the color plate data of each color of KCMY. The pretreatment data generation described at step S103 will be described later with reference to FIG. 11B. At step S104, the controller 500 performs halftone processing (quantization processing) on the color plate data of each color of KCMY, prints using the head units 50 and 55 based on the obtained data, and ends the present processing at step S105.

FIG. 11B is a flowchart illustrating the pretreatment data generation processing executed in the printer.

The processing illustrated in FIG. 11B is called at step S103 of FIG. 11A and starts from step S200. At step S201, the controller 500 calculates a printing region of the color image based on the color plate data of KCMY. In processing of calculating the printing region of the color image at step S201, logical sum (OR) processing of the generated KCMY color plate data is performed to generate binary data indicating whether or not there is a color pixel. A region including the color pixel is referred to as a color image printing region. At step S202, the controller 500 calculates a pretreatment liquid application region based on the color image printing region. At step S203, the controller 500 generates pretreatment data based on the calculated pretreatment liquid application region, and ends the present processing at step S204 to return to the flow illustrated in FIG. 11A.

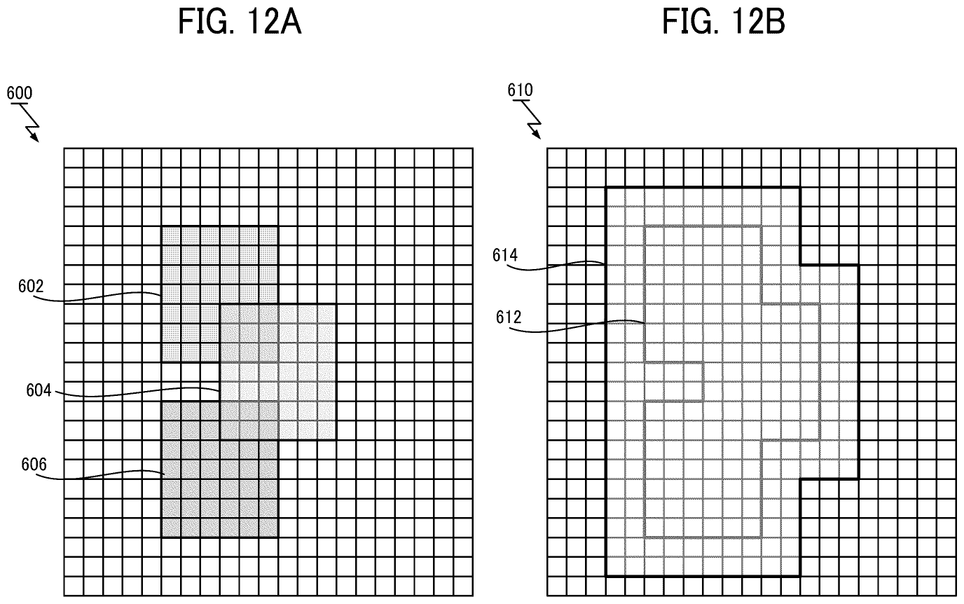

FIGS. 12A and 12B are diagrams for illustrating processing of calculating the pretreatment liquid application region from the color plate data of KCMY. FIG. 12A illustrates an image of the color image to be input in image data 600, and FIG. 12B illustrates an image of the pretreatment liquid application region (before the halftone processing) calculated based on each color plate of the color image in image data 610. In the example illustrated in FIG. 12A, three rectangular filled regions (602, 604, 606) are drawn in a partially overlapped manner in the color image. In the image illustrated in FIG. 12B, a contour 612 indicates a contour of an image obtained by combining the filled regions (602, 604, 606) of the color image illustrated in FIG. 12A, and a contour 614 slightly larger than the contour indicates the pretreatment liquid application region. Here, regarding a degree by which a printing range is widened with respect to the color image, there is a set value inside the controller 500, and the pretreatment liquid application region 604 is calculated by enlarging the color image region 602 by the set value.

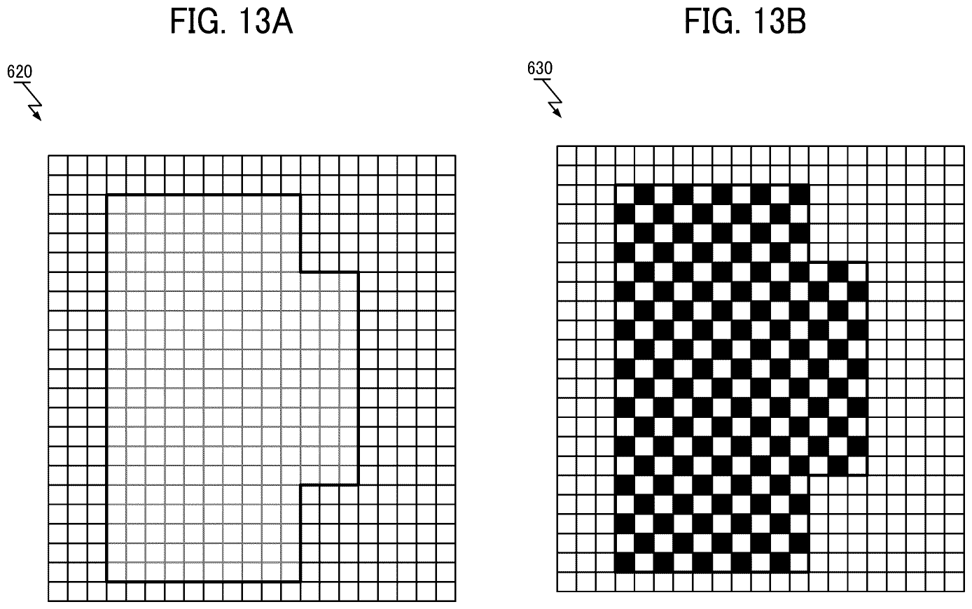

FIGS. 13A and 13B are diagrams for illustrating the halftone processing of the pretreatment liquid application region. FIG. 13A is an image illustrating the pretreatment liquid application region before the halftone processing in image data 620. FIG. 13B is an image of the pretreatment data after the halftone processing in image data 630. As illustrated in FIGS. 13A and 13B, the pretreatment data is subjected to the halftone processing similarly to the color image, and is transferred to the pretreatment liquid head array 51UC as dot arrangement data.

In this manner, the controller 500 calculates the pretreatment liquid application region in a range wider than the ink application region to which the printing ink is applied based on the color image data.

The data obtained by the halftone processing of the color plate data of KCMY and the pretreatment data described above are transferred to the printing ink head array 51BK/51Cy/51Ma/51Ye and the pretreatment liquid head array 51UC, and printing is executed, whereby the pretreatment liquid is applied to the pretreatment liquid application region of the continuous body 10 by the pretreatment liquid head array 51UC, and then the printing ink is discharged by the printing ink head array 51BK/51Cy/51Ma/51Ye into the region to which the pretreatment liquid is applied, so that an image is formed.

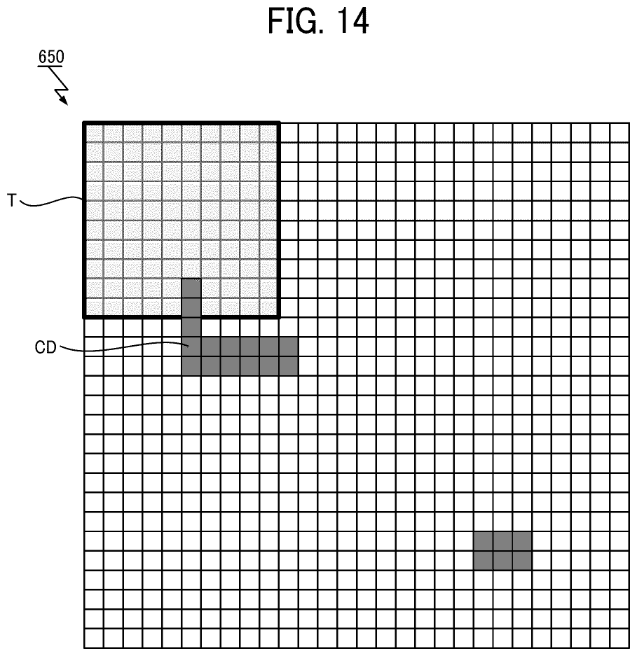

Hereinafter, calculation processing of the pretreatment region will be described more specifically with reference to FIGS. 14 to 16. FIGS. 14 to 16 are diagrams for illustrating the calculation processing of the pretreatment region executed by the printer 1000 (inkjet printer). Regarding print data in the width direction, the print data of the pretreatment is larger than the KCMY color plate data, so that FIGS. 14 to 16 correspond to that obtained by performing logical sum (OR) processing of the generated KCMY color plate data and further superimposing the obtained data on a printable region of the pretreatment.

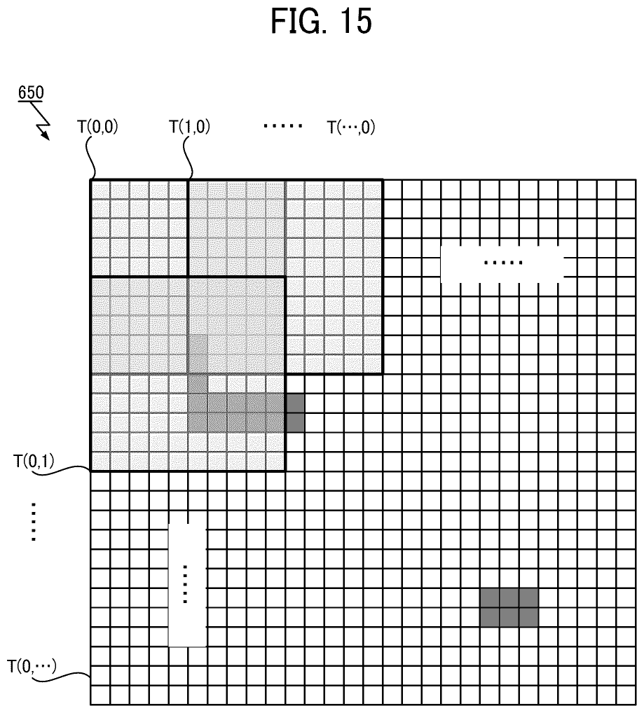

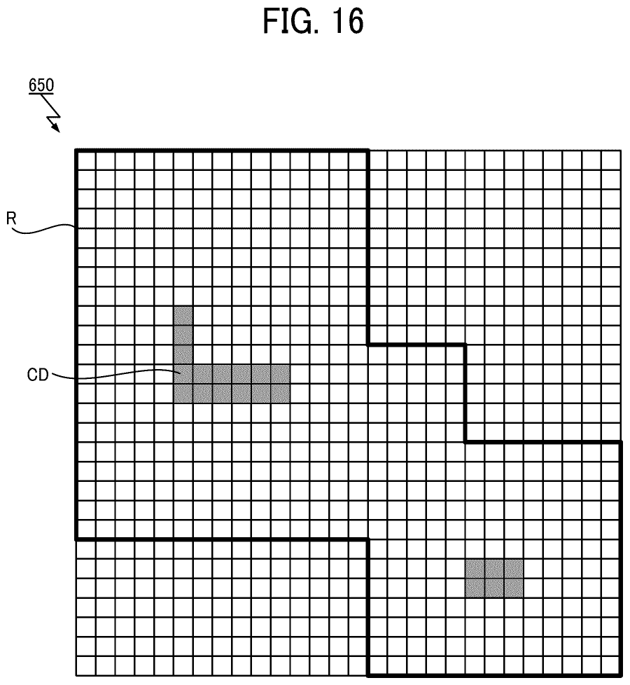

Specifically, the calculation processing of the pretreatment region is executed in three stages of (1) as illustrated in FIG. 14, an image inspection range T of a predetermined range is set for data 650 obtained by performing logical sum of all colors. Here, the presence or absence of a color pixel CD is determined in the image inspection range T. (2) As illustrated in FIG. 15, in the image inspection, the presence or absence of the color pixel is determined while shifting (T(0,0)→T(1,0)→ . . . T( . . . ,0)→T(0,1)→ . . . T(0,2)→ . . . T(0, . . . )→ . . . ) in a horizontal direction and in a vertical direction by ½ of the image inspection range T. (3) As illustrated in FIG. 16, in a case where there is the color pixel in the image inspection range T, a region of the image inspection range T is set as a pretreatment liquid application completion region R.

In the processing of (1) and (2) described above, calculation is performed using, as input data, data indicating the presence or absence of the color pixel obtained by performing logical sum processing on the KCMY plane data. The image inspection range T of a predetermined size is set for the input data indicating the presence or absence of the color pixel, and it is determined whether or not the color pixel is present within the image inspection range T. Here, the size of the image inspection range T is determined by setting how much the pretreatment data is enlarged with respect to the color image. In a case where there is the color pixel in the image inspection range T, all the pixels in the image inspection range T are set to pixels (for example, “1”) in a range where the pretreatment liquid is applied. The image inspection range T is shifted in the vertical direction and the horizontal direction by ½ of the pixels of the image inspection range, and the presence or absence of the color pixel is determined.

Finally, a region R obtained by combining the image inspection ranges T determined as “1” in the determination of the presence or absence of the color pixel is the range to which the pretreatment liquid is applied.

According to the embodiment described above, since the printable region of the pretreatment liquid head array 51UC is wider than that of the printing ink head array 51BK/51Cy/51Ma/51Ye, the printable region of the pretreatment liquid head array 51UC is likely to remain outside the printable region of the printing ink head array 51BK/51Cy/51Ma/51Ye even if misregistration occurs. This makes it possible to prevent a case where the treatment liquid cannot be applied to the outside of the image at the end.

In the embodiment described above, a so-called rotary printing machine in which the image 14 is formed by the pretreatment liquid and the printing ink discharged from the head unit 55 and the head unit 50 in the print unit 5 on the continuous body 10 fed from the original winding roller 11 of the carry-in unit 1 and conveyed has been described as an example. However, the inkjet image forming apparatus according to the embodiment of the present disclosure is not limited to the rotary printing machine, and may be configured as a sheet printing machine, and is not limited.

In the embodiment described above, the characteristic in the configuration of forming the image on the pretreatment layer 12 with the printing ink after applying the pretreatment liquid has been described. However, there is a similar problem in the configuration in which a post-treatment liquid is applied, and the characteristic according to the embodiment of the present disclosure can also be applied to the configuration in which the post-treatment liquid is applied onto the image after the image is formed on the medium by the printing ink.

In the present application, discharged “ink” and “treatment liquid” are not limited in particular as long as the liquid has a viscosity or surface tension to be discharged from the head. However, preferably, the viscosity of the liquid is not greater than 30 mPa·s under ordinary temperature and ordinary pressure or by heating or cooling. The “ink” and “treatment liquid” are solutions, suspensions, emulsions and the like containing solvents such as water and organic solvents, colorants such as dyes and pigments, function-imparting materials such as polymerizable compounds, resins, and surfactants, edible materials such as natural pigments and the like, and these can be used, for example, in applications such as inkjet inks. The “printing ink” refers to a colored one of the “inks” used in printing. The “pretreatment liquid” for the printing ink refers to any liquid having an effect of improving the properties of the printing ink such as blur prevention and color development as a primer of the printing ink. The post-treatment liquid for the printing ink refers to any liquid having an effect of improving the performance of the printing ink, such as improving image friction resistance, as an overcoat.

Examples of the “inkjet head” include, as an energy source to discharge liquid, those using a piezoelectric actuator (a laminated piezoelectric element or a thin-film piezoelectric element), a thermal actuator that employs a thermoelectric conversion element, such as a heating resistor, and an electrostatic actuator including a diaphragm and opposed electrodes.

The term “medium” represents a medium onto which liquid can be at least temporarily adhered, a medium onto which liquid is adhered and fixed, or a medium into which liquid adheres and permeates. Specific examples thereof include recording media such as paper, recording paper, recording sheet, film, and cloth, and include all materials to which liquid adheres unless otherwise specified. Examples of the material thereof include paper, thread, fiber, cloth, leather, metal, plastic, glass, wood, and ceramics.

Each function of the embodiments described above can be implemented by one processing circuit or multiple processing circuits. Here, the term “processing circuit or circuitry” in the present embodiment includes a programmed processor to execute each function by software, such as a processor implemented by an electronic circuit, and devices, such as an application specific integrated circuit (ASIC), a digital signal processor (DSP), a field programmable gate array (FPGA), a system on a chip (SOC), a GPU, and conventional circuit modules designed to execute each function described above.

The functions described above may be implemented by a computer-executable program described in a legacy programming language such as assembler, C, C++, C#, and Java (registered trademark), an object-oriented programming language or the like, and may be distributed in a manner stored in a device-readable recording medium such as a ROM, an electrically erasable programmable read-only memory (EEPROM), an erasable programmable read-only memory (EPROM), a flash memory, a flexible disk, a compact disc read-only memory (CD-ROM), a compact disc rewritable (CD-RW), a digital versatile disc read-only memory (DVD-ROM), a digital versatile disc random-access memory (DVD-RAM), a digital versatile disc-rewritable (DVD-RW), a Blu-ray Disc, a secure digital (SD) card, or a magneto-optical (MO) disk, or via an electric communication line.

An image forming apparatus includes: a first head array having a first printable region having a first printable width in a width direction, to apply a pretreatment liquid on a medium conveyed in a conveyance direction orthogonal to the width direction; a second head array having a second printable region having a second printable width smaller than the first printable width in the width direction, to apply ink onto the medium; and circuitry configured to control the first head array and the second head array to apply the ink over the pretreatment liquid on the medium.

The first head array includes first inkjet heads to discharge the pretreatment liquid onto the medium, the second head array includes second inkjet heads to discharge the ink to the medium, the first head array extends in the width direction to cover the first printable region in the width direction, and the second head array extends in the width direction to cover the second printable region in the width direction.

Each of the first inkjet heads of the first head array has first nozzles to discharge the pretreatment liquid from the first nozzles, the first nozzles in the first inkjet heads of the first head array are arrayed in the width direction, to cover the first printable width of the first printable region in the width direction, and each of the second inkjet heads of the first head array has second nozzles to discharge the ink from the second nozzles, the second nozzles in the second inkjet heads of the second head array are arrayed in the width direction, to cover the second printable width of the second printable region in the width direction.

Each of the first inkjet heads has first nozzles to discharge the pretreatment liquid from the first nozzles, each of the second inkjet heads has second nozzles to discharge the ink from the second nozzles, the circuitry is further configured to: control the first inkjet heads to use a first number of the first nozzles to discharge the pretreatment liquid from the first nozzles, control the second inkjet heads to use a second number, smaller than the first number, of the second nozzle to discharge the ink from the second nozzles.

The first head array has a first width in the width direction; and the second head array has a second width smaller than the first width in the width direction. The first head array includes a first number of the first inkjet heads arranged in a staggered manner in the width direction, and the second head array includes a second number, smaller than the first number, of the second inkjet heads arranged in a staggered manner in the width direction.

The first head array includes the first inkjet heads arranged in a staggered manner in the width direction, at least two of the first inkjet heads are: adjacent to each other in the conveyance direction; and overlapped with a first overlapping width in the width direction, the second head array includes the second inkjet heads arranged in a staggered manner in the width direction, at least two of the second inkjet heads are: adjacent to each other in the conveyance direction; and overlapped with a second overlapping width, wider than the first overlapping width, in the width direction. The circuitry is further configured to: control the first head array to apply the pretreatment liquid to the first printable region in the medium, as a base under the ink of both: the second printable region; and a boundary region around the second printable region.

The circuitry is further configured to: receive image data; calculate the first printable region having an area larger than an area of the second printable region based on the image data; and control the first head array to apply the pretreatment liquid to the first printable region in the medium; and control the second head array to apply the ink in the second printable region based on the image data, to form an image on the medium.

With the above configuration, it is possible to prevent a case where the treatment liquid cannot be applied to the outside of the image at the end due to misregistration.

Although the image processing apparatus according to an embodiment of the present embodiment has been described so far, the present embodiment is not limited to the above-described embodiment, and can be changed within a range that can be conceived by those skilled in the art, such as addition, change, or deletion of other embodiments, and any aspect is included in the scope of the present embodiment as long as the action and effect of the present embodiment are achieved.

Aspects of the present disclosure are as follows, for example.

According to Aspect 1, an image forming apparatus includes:
a treatment liquid head array for applying a treatment liquid;
an ink head array for applying ink; and
a controller that controls the treatment liquid head array and the ink head array to apply the treatment liquid and the ink onto a medium in an overlapping manner,
in which the treatment liquid head array has a wider printable region than the ink head array.

According to Aspect 2, in the image forming apparatus of Aspect 1,
the treatment liquid head array discharges a pretreatment liquid as the treatment liquid to the medium by an inkjet system, the ink head array discharges the ink to the medium onto which the pretreatment liquid is applied by an inkjet system, and the image forming apparatus is a single-pass inkjet apparatus.

According to Aspect 3, in the image forming apparatus of Aspect 2,
the printable region is a printable width defined by nozzle arrangement of the ink head array and the treatment liquid head array.

According to Aspect 4, in the image forming apparatus of any one of Aspects 1 to 3,
the treatment liquid head array includes a larger number of nozzles used for discharge than the ink head array.

According to Aspect 5, in the image forming apparatus of any one of Aspects 1 to 3,
the treatment liquid head array is wider than the ink head array.

According to Aspect 6, in the image forming apparatus of Aspect 5,
the treatment liquid head array includes multiple treatment liquid heads arranged alternately, the ink head array includes multiple inkjet heads arranged alternately, and the number of the treatment liquid heads is larger than the number of the inkjet heads.

According to Aspect 7, in the image forming apparatus of Aspect 5,
a width of an overlapping region between at least two heads of the treatment liquid head array is wider than a width of an overlapping region between at least two heads of the ink head array.

According to Aspect 8, in the image forming apparatus of any one of Aspects 1 to 7,
the treatment liquid is applied as a base of both a printing region to which the ink is applied and a boundary region around the printing region.

According to Aspect 9, in the image forming apparatus according to any one of Aspects 1 to 8,
the controller is configured to calculate a treatment liquid application region in a range wider than an ink application region to which the ink is applied based on image data, apply the treatment liquid to the treatment liquid application region of the medium by the treatment liquid head array, and then discharge the ink in a region to which the treatment liquid is applied to form an image.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An image forming apparatus comprising:
a first head array having a first printable region having a first printable width in a width direction,
to apply a pretreatment liquid on a medium conveyed in a conveyance direction orthogonal to the width direction;
a second head array having a second printable region having a second printable width smaller than the first printable width in the width direction,
to apply ink onto the medium; and
circuitry configured to control the first head array and the second head array to apply the ink over the pretreatment liquid on the medium.

2. The image forming apparatus according to claim 1,
wherein the first head array includes first inkjet heads to discharge the pretreatment liquid onto the medium,
the second head array includes second inkjet heads to discharge the ink to the medium,
the first head array extends in the width direction to cover the first printable region in the width direction, and
the second head array extends in the width direction to cover the second printable region in the width direction.

3. The image forming apparatus according to claim 2,
wherein each of the first inkjet heads of the first head array has first nozzles to discharge the pretreatment liquid from the first nozzles,
the first nozzles in the first inkjet heads of the first head array are arrayed in the width direction,
to cover the first printable width of the first printable region in the width direction, and
each of the second inkjet heads of the first head array has second nozzles to discharge the ink from the second nozzles,
the second nozzles in the second inkjet heads of the second head array are arrayed in the width direction,
to cover the second printable width of the second printable region in the width direction.

4. The image forming apparatus according to claim 2,
wherein each of the first inkjet heads has first nozzles to discharge the pretreatment liquid from the first nozzles,
each of the second inkjet heads has second nozzles to discharge the ink from the second nozzles,
the circuitry is further configured to:
control the first inkjet heads to use a first number of the first nozzles to discharge the pretreatment liquid from the first nozzles,
control the second inkjet heads to use a second number, smaller than the first number, of the second nozzle to discharge the ink from the second nozzles.

5. The image forming apparatus according to claim 2,
wherein the first head array has a first width in the width direction; and
the second head array has a second width smaller than the first width in the width direction.

6. The image forming apparatus according to claim 5,
wherein the first head array includes a first number of the first inkjet heads arranged in a staggered manner in the width direction, and
the second head array includes a second number, smaller than the first number, of the second inkjet heads arranged in a staggered manner in the width direction.

7. The image forming apparatus according to claim 5,
wherein the first head array includes the first inkjet heads arranged in a staggered manner in the width direction,
at least two of the first inkjet heads are:
adjacent to each other in the conveyance direction; and
overlapped with a first overlapping width in the width direction,
the second head array includes the second inkjet heads arranged in a staggered manner in the width direction,
at least two of the second inkjet heads are:
adjacent to each other in the conveyance direction; and
overlapped with a second overlapping width, wider than the first overlapping width, in the width direction.

8. The image forming apparatus according to claim 2,
wherein the circuitry is further configured to:
control the first head array to apply the pretreatment liquid to the first printable region in the medium,
as a base under the ink of both:
the second printable region; and
a boundary region around the second printable region.

9. The image forming apparatus according to claim 2,
wherein the circuitry is further configured to:
receive image data;
calculate the first printable region having an area larger than an area of the second printable region based on the image data; and
control the first head array to apply the pretreatment liquid to the first printable region in the medium; and
control the second head array to apply the ink in the second printable region based on the image data,
to form an image on the medium.
